(19) United States
(12) Patent Application Publication
(10) Pub. No.: US 2013/0262327 A1
(43) Pub. Date: Oct. 3, 2013

(54) METHOD FOR DIVORCE DISCLOSURE PROCESSING

(71) Applicant: Elisabeth Camaur-Crampton, Irvine, CA (US)

(72) Inventor: Elisabeth Camaur-Crampton, Irvine, CA (US)

(21) Appl. No.: 13/437,930

(22) Filed: Apr. 3, 2012

(51) Int. Cl. G06Q 50/18

(52) U.S. Cl. 705/311

(57) ABSTRACT

A computer and software based method processes and completes procedures and documentation for a divorce or legal separation. One or more users establishes an account associated with a secure vault system wherein the one or more users may store information pertaining to the divorce or legal separation proceeding. A facilitated exchange of this information and relevant documents according to the disclosures and exchange of information required under laws pertaining to divorce or legal separation proceedings is also made possible through a secure vault system.

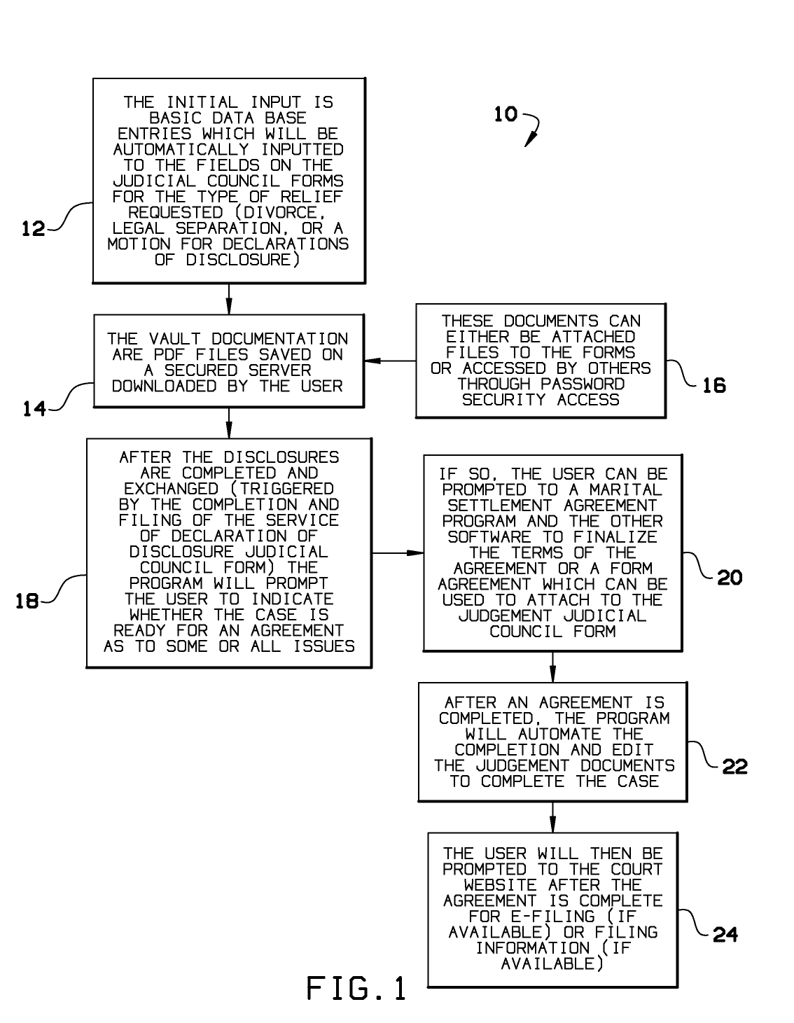

### BACKGROUND OF THE INVENTION

This invention relates, in part, to document generating systems and methods, including documents for use in divorce and legal separation proceedings.

In many legal proceedings, the major costs are associated with the time and expertise required to generate the required paperwork. The time and expertise are often required even when the legal proceeding itself is essentially a formality. In an uncontested divorce proceeding, there are a number of documents that must be prepared and filed. Completing these forms can be daunting to a layperson. A need exists to aid a layperson in the process of filling out divorce or legal separation documents.

Furthermore, divorce and legal separation proceedings typically require parties participating in the proceeding to provide one another with information regarding such matters as income, real estate holdings, taxes, personal possessions, accounts, pensions, insurance, investments, business information, debts, liens, loans, bank accounts, and other financial information. Sharing this information by sending either electronic documents or physical documents over email or through traditional mail or messenger frequently results in misplaced information and lost time. A need exists to facilitate sharing of the relevant information between participating parties at a centralized location.

### SUMMARY OF THE INVENTION

Broadly, an embodiment of the present invention generally provides systems and methods for processing and completing the necessary disclosures and documentation for a divorce or legal separation in a given state. The embodiments of the present invention may also facilitate any required document exchanges necessary to complete the disclosure and exchange of information requirements, such as under the relevant codes of the given state.

### BRIEF DESCRIPTION OF THE DRAWINGS

The FIGURE depicts a flowchart illustrating a method of disclosure and divorce or legal separation processing in accordance with an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The FIGURE shows a method 10 of divorce processing, which may be implemented as computer software running on one or more processors, computer hardware, physical processes, or a combination of computer software, computer hardware, and physical processes. In the case of computer software, a user may download the software through a network, such as the Internet, may use the software as a web application on a website, or may purchase a physical copy of the software embedded upon a computer readable storage medium. The software may be loaded and stored upon a computer-readable storage medium, such as a hard drive, and the software may be executed on one or more processors in the computer.

As a preliminary matter, a user, such as a person seeking to file a divorce or legal separation in a given state, may establish an account within the system of the present invention. The computer software, computer hardware, physical processes or a combination thereof causes a displaying to the user, at a display of an electronic computing device, one or more account information graphical user interfaces including prompts inviting the user to input first user identifying information. In some embodiments, this identifying information includes a user password and a user name. After entry of this identifying information into input receptacles provided at the one or more account information graphical user interfaces, the identifying information is stored in a memory of a database server and associated with an online accessible account.

At 12, the user may choose to open a previously saved case or to create a new case, and the user may be prompted to indicate whether the case is regarding a divorce or legal separation, and the user may also be prompted to input information and data relevant to the divorce or legal separation proceeding. The user may be prompted for the information by displaying, to the user at a display of an electronic computing device, a plurality of legal information graphical user interfaces including prompts for the user to enter information relevant to a divorce or legal separation proceeding. The relevant input information is received in input boxes provided at the legal information of graphical user interfaces, stored in the memory of the database server and associated with the established account of the user.

The information input may be automatically inputted on to the appropriate proper judicial council forms and/or other forms. Such information and data may include, as a non-exhaustive example, the parties' names, dates of birth, social security numbers, and addresses, court information, date of marriage, date of separation, information concerning the parties' children, income information, real estate holdings information, tax information, personal possessions, accounts, pensions, insurance, investments, business information, debts, liens, loans, bank accounts, financial information, and any other necessary or relevant information.

Additional, secondary information about the parties which is relevant to the divorce or legal separation proceeding may also be automatically gathered. For example, using the bank account and financial information inputted by the user, financial accounts of the parties might be accessed automatically via online banking or other methods so that additional financial information may be gathered and accessible for input into forms, saved in the vault application and/or exchanged in disclosures.

The relevant information or secondary information or a combination of both may then be provided into one or more virtual legal forms associated with the geographical region of the divorce or legal separation proceeding and necessary for filing during as part of the divorce or legal separation proceeding. In some embodiments, the forms need no be virtual.

In some embodiments, instructions for filling out input boxes for legal information pertaining to the divorce or legal separation proceeding are provided to the user in the form of a webinar.

At 14, the user may be provided with an electronic vault associated with the account, which may be a secure database server for storing various important documents, such as financial records, legal documents, and any other important documents. The documents may be files relating to the relevant information and/or secondary information that the user had previously provided.

At 16, the user may be able to create and edit access rules, to select particular documents within the vault and/or downloaded into the program that may be accessed by the user or one or more additional users who have also established an account according to the description above. For example, the user may create a password and access rules for his or her attorney, so that the attorney is able to access certain documents within the electronic vault and/or online financial account information.

The user or one or more additional users may also be prompted to complete and/or edit the relevant forms for court filings regarding the divorce, legal separation, motion for child custody, other motions as well as any disclosures required by law. The user may be automatically provided the necessary forms for the user based on the relevant information inputted by the user. Portions of the forms may also be automatically filled out based on the information inputted by the user as well as additional information that were automatically gathered. The user may also be provided with a user interface that allows the user to select connections to other divorce-related software, such as a child/spousal support calculator, property division software, or any other relevant software. The user may also be re-directed to the local county court website so that the user may be able to review their online case information, to review local county rules, and to electronically file his or her case (if available).

At 18, the forms and/or disclosures completed by the user may be exchanged, printed, electronically sent to the another party associated with the divorce or legal separation proceeding electronically and electronically filed with the court. The user may be prompted as to whether the case is ready for an agreement and/or stipulated judgment as to some or all issues. At 20, if the case is ready for an agreement/stipulated judgment, the user may be prompted to a marital settlement agreement program and/or other software in order to finalize the terms of the agreement/stipulated judgment. A form agreement/stipulated judgment may be used which may be attached to the judgment judicial council form.

At 22, after an agreement and/or stipulated judgment has been completed, the judgment documents may be automatically completed and edited.

At 24, the user may be prompted to the court website after the agreement is complete so that the agreement may be e-filed (if available), or so that the user may find the necessary filing information on the court website.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

What is claimed is:

1. A computer-implemented method for facilitating divorce or legal separation processing, comprising the steps of:
prompting a user to input information;
downloading additional information based on the inputted information;
filling in legal forms based on the inputted information and the downloaded additional information;
storing documents and information within a secure vault;
securely exchanging required disclosures and/or exchange of information;
interacting with other relevant software for the family law process; and
compiling, servicing, printing, and electronically filing the legal forms with a court.

2. A computer-implemented method for facilitating divorce or legal separation processing, comprising the steps of:
displaying to a first user, at a display of an electronic computing device, one or more first account information graphical user interfaces including prompts inviting said first user to input first user identifying information;
wherein said identifying information includes a first user password and a first user name;
storing said first user identifying information in a memory of a database server;
associating said first user identifying information with an account of said first user;
displaying, to said first user at a display of an electronic computing device,
a plurality of legal information graphical user interfaces including prompts for said first user to enter information relevant to a divorce or legal separation proceeding;
receiving said relevant information in input boxes provided at the legal information of graphical user interfaces;
storing said relevant information in said memory of said database server;
associating said relevant information with said account of said first user;
downloading, to said database server, through a network of electronic computing devices, secondary information relevant to said divorce or legal separation proceeding based on said relevant information;
providing said relevant information and said secondary information to one or more virtual legal forms associated with the geographical region of said divorce or legal separation proceeding and necessary for filing during said divorce or legal separation proceeding;
storing one or more divorce or legal separation documents and said virtual legal forms within a secure virtual vault, said virtual vault designating one or more spaces in said memory of said database server;
displaying, to one or more additional users, at a display of an electronic computing device, one or more additional account information graphical user interfaces including prompts inviting said one or more additional users to input additional user identifying information;
wherein said additional user identifying information includes one or more additional user passwords and one or more additional user names;
storing said additional user identifying information in said memory of said database server;
associating said additional user identifying information with one or more accounts of said one or more additional users;
wherein said virtual vault is accessible to said first user and said one or more additional users upon determination by said server that identifying information entered into a log-in graphical user interface by said first user or said one or more additional users matches said first user identifying information or said additional user identifying information of said one or more registered users;
displaying, to said one or more additional users at a display of an electronic computing device, a plurality of additional legal information graphical user interfaces including prompts for said one or more additional users to enter additional information relevant to said divorce or legal separation proceeding;
receiving said additional relevant information in input boxes provided at the additional legal information graphical user interfaces;
storing said additional relevant information in said memory of said database server;
associating said additional relevant information with said accounts of said one or more additional users;
downloading, to said database server, through a network of electronic computing devices, additional secondary information relevant to said divorce or legal separation proceeding based on said additional relevant information;
providing said additional relevant information and said additional secondary information to one or more virtual legal forms associated with the geographical region of said divorce or legal separation proceeding and necessary for filing during said divorce or legal separation proceeding;
storing one or more divorce or legal separation documents and said virtual legal forms within said secure virtual vault;
securely providing to said first user and one or more additional users,
one or more of said one or more divorce or legal separation documents and said legal forms; and
compiling, servicing, printing, and electronically filing said legal forms with a court having jurisdiction in the geographic region of the divorce or legal separation proceeding.

3. A computer-implemented method for facilitating divorce or legal separation processing, comprising the steps of:
displaying, to said first user at a display of an electronic computing device,
a plurality of legal information graphical user interfaces including prompts for a first user to enter information relevant to a divorce or legal separation proceeding;
receiving said relevant information in input boxes provided at the legal information of graphical user interfaces;
storing said relevant information in said memory of said database server;
associating said relevant information with an account of said first user;
downloading, to said database server, through a network of electronic computing devices, secondary information relevant to said divorce or legal separation proceeding based on said relevant information;
providing said relevant information and said secondary information to one or more virtual legal forms associated with the geographical region of said divorce or legal separation proceeding and necessary for filing during said divorce or legal separation proceeding;
storing one or more divorce or legal separation documents and said virtual legal forms within a secure virtual vault, said virtual vault designating one or more spaces in said memory of said database server.

4. A computer-implemented method for facilitating divorce or legal separation processing as set forth in claim 3, further comprising the steps of:
displaying to said first user, at a display of an electronic computing device, one or more first account information graphical user interfaces including prompts inviting said first user to input first user identifying information;
wherein said identifying information includes a first user password and a first user name;
storing said first user identifying information in a memory of a database server;
associating said first user identifying information with said account of said first user.

5. A computer-implemented method for facilitating divorce or legal separation processing as set forth in claim 4, further comprising the steps of:
displaying, to one or more additional users, at a display of an electronic computing device, one or more additional account information graphical user interfaces including prompts inviting said one or more additional users to input additional user identifying information;
wherein said additional user identifying information includes one or more additional user passwords and one or more additional user names;
storing said additional user identifying information in said memory of said database server;
associating said additional user identifying information with one or more accounts of said one or more additional users.

6. The computer-implemented method for facilitating divorce or legal separation processing as set forth in claim 5, further comprising the steps of:
displaying, to said one or more additional users at a display of an electronic computing device, a plurality of additional legal information graphical user interfaces including prompts for said one or more additional users to enter additional information relevant to said divorce or legal separation proceeding;
receiving said additional relevant information in input boxes provided at the additional legal information graphical user interfaces;
storing said additional relevant information in said memory of said database server;
associating said additional relevant information with said accounts of said one or more additional users;
downloading, to said database server, through a network of electronic computing devices, additional secondary information relevant to said divorce or legal separation proceeding based on said additional relevant information;
providing said additional relevant information and said additional secondary information to one or more virtual legal forms associated with the geographical region of said divorce or legal separation proceeding and necessary for filing during said divorce or legal separation proceeding;
storing one or more divorce or legal separation documents and said virtual legal forms within said secure virtual vault.

7. The computer-implemented method for facilitating divorce or legal separation processing as set forth in claim 6, further comprising the steps of:
providing, to said one or more additional users in the form of a webinar, instructions relevant for entering said relevant information.

8. The computer-implemented method for facilitating divorce or legal separation processing as set forth in claim 6, wherein:
said virtual vault is accessible to said first user and said one or more additional users upon determination by said server that identifying information entered into a log-in graphical user interface by said first user or said one or more additional users matches said first user identifying information or said additional user identifying information of said one or more registered users.

9. The computer-implemented method for facilitating divorce or legal separation processing as set forth in claim 8, further comprising the steps of:
securely providing, to said first user and one or more additional users through said virtual vault, one or more of said one or more divorce or legal separation documents and said legal forms; and
compiling, servicing, printing, and electronically filing said legal forms with a court having jurisdiction in the geographic region of the divorce or legal separation proceeding.

10. The computer-implemented method for facilitating divorce or legal separation processing as set forth in claim 3, further comprising the steps of:
providing, to said first user in the form of a webinar, instructions relevant for entering said relevant information.
